(19) United States
(12) Patent Application Publication
(10) Pub. No.: US 2011/0247183 A1
(43) Pub. Date: Oct. 13, 2011

(54) Plunger pin shackle locking apparatus

(76) Inventors: Timothy T. Tylaska, Preston, CT (US); Thomas W. Dixon, New London, CT (US)

(21) Appl. No.: 13/066,107

(22) Filed: Apr. 6, 2011

Related U.S. Application Data
(60) Provisional application No. 61/341,939, filed on Apr. 7, 2010.

(51) Int. Cl. F16B 45/02

(52) U.S. Cl. 24/601.5

(57) ABSTRACT

A plunger pin schackle locking apparatus that prevents accidental release of the snap shackle under heavy flogging during windy conditions or snagging. Two “at-rest” states or positions are provided. This first one prevents significant translation of the plunger pin such that apparatus remains closed and locked. The second one allows free translation of the plunger pin over a range sufficient to release the latch. The locking mechanism does not significantly change the overall configuration, size and relative dimensions of a similarly rated but non-locking equivalent plunger pin snap shackle to allow for interchangeability.

This application claims benefit of U.S. Provisional Application Ser. No. 61/341,939 filed Apr. 7, 2010 pursuant to 35 USC §119(e).

### FIELD OF THE INVENTION

This invention relates to fasteners, in particular, to shackles used for joining two members together.

### BACKGROUND OF THE INVENTION

Plunger pin snap shackles are most commonly used in sailing but are used in a variety of applications where it is desirable to join and disjoin two members with relative ease. There are numerous situations, particularly in sailing, when a snap shackle may accidentally open. Massive accelerations that occur when the sails and attached rigging experience flogging can sometimes cause a plunger pin to accidentally open due to inertial forces that overcome the resistive forces of the plunger spring. Snagging of the plunger pin sometimes also occurs when the shackle is dragged across the deck or hoisted up the mast. For these applications, it is desirable to have a locking mechanism that holds the plunger pin captive to prevent such accidental release from occurring. It is also desirable in these situations to have a locking mechanism that is relatively simple and easy to operate.

A typical plunger pin snap shackle consists of a main body, a plunger pin, a plunger spring, a hook and a bail. One of the two members to be joined is attached to a bail and the other attached to a hook. Upon retraction of the plunger pin, the hook is allowed to pivot free from the main body, disjoining the two members. Frequently, these shackles are attached to ropes and sails that, as noted above, can experience violent flogging in windy conditions. Under these conditions the shackle can sometimes release unintentionally, resulting in a malfunction of the sailboat and possible loss of equipment or injury to the crew.

There is not found in the prior art a locking plunger pin snap shackle that has a lock that cannot be released unintentionally during extreme conditions yet can be quickly and easily released and disengaged by a user.

### SUMMARY OF THE INVENTION

It is an aspect of the invention to provide a plunger pin snap shackle with a lock which prevents the accidental release of the snap shackle under heavy flogging during windy conditions or snagging.

Another aspect on the invention is to provide a plunger snap shackle with a lock that can exist at two “at-rest” states; one which prevents significant translation of the plunger pin and one which allows free translation of the plunger pin over a range sufficient to release the latch.

Yet another aspect of the invention is to provide a plunger pin snap shackle with a lock that can easily and quickly be engaged and disengaged by the operator.

Another aspect of the invention is to provide a plunger pin snap shackle with a lock wherein the locking mechanism itself has a configuration that does not create an additional snagging hazard.

Another aspect of the invention is to provide a plunger pin snap shackle with a locking mechanism which does not significantly change the overall configuration, size and relative dimensions of a similarly rated but non-locking equivalent plunger pin snap shackle to allow for interchangeability.

A final aspect of the invention is to provide a plunger pin snap shackle that has a means of holding the plunger pin captive in both the engaged state and disengaged state of the lock.

### BRIEF DESCRIPTION OF THE DRAWINGS

FIG. 1 is a sectional side view of the locking plunger pin snap shackle in the locked state in accordance with the invention.

FIG. 2 is a sectional side view of the locking plunger pin snap shackle in the open state in accordance with the invention.

FIG. 3 is a sectional side view of the locking plunger pin snap shackle with the plunger pin, lock pin, snap ring, and spring removed to show a detailed view of the locking cavity in the main body.

FIG. 4 is a trimetric view of the locking plunger pin snap shackle in the unlocked position.

FIGS. 5-8 are progressive operational views of the plunger pin locking mechanism.

### DETAILED DESCRIPTION OF THE INVENTION

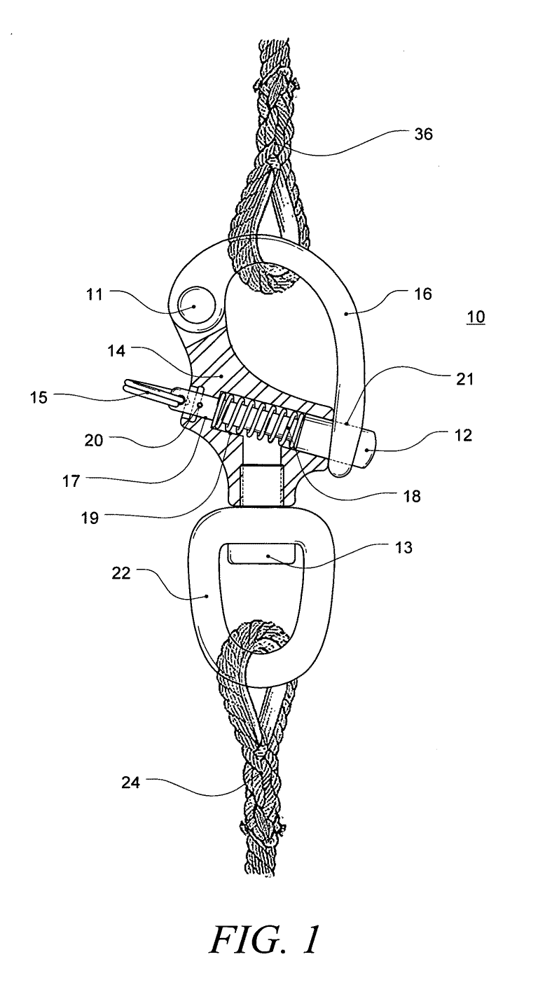

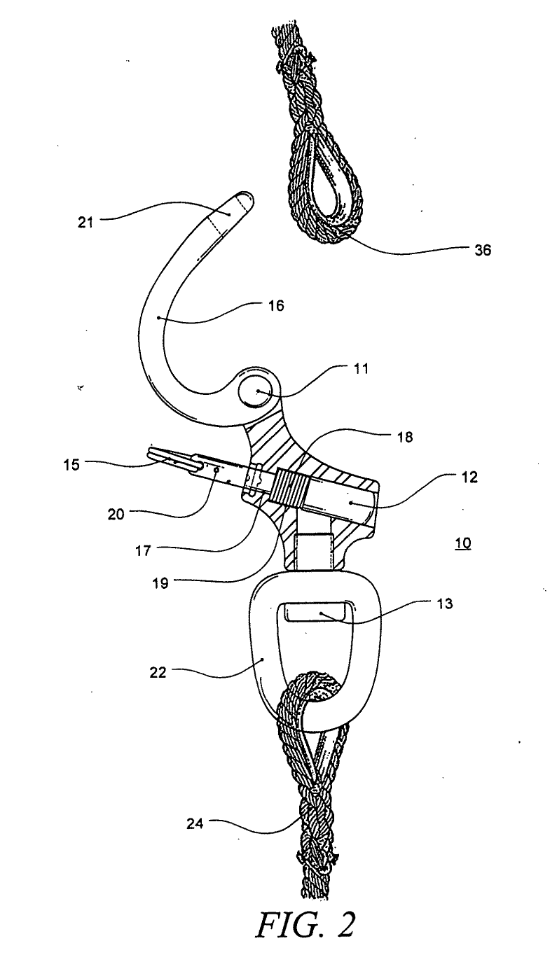

The most basic configuration of the locking plunger pin snap shackle according to the invention comprises a plunger pin, a lock pin, a spring, a main body, a hook and a bail. This configuration, as shown in FIG. 1 and further detailed in FIGS. 2-8, is suitable for pull pin style sailing snap shackles. Variations in size and shape in accordance with the mechanism may be necessary for different applications.

The locking plunger pin snap shackle 10 connects together members 24 and 36, in this case, lines with a thimble spliced therein. The shackle 10 comprises a main body 14, a pivot pin 11, a hook 16, a lock pin 20, a spring 18, a plunger pin 12, a snap ring 15, a threaded or welded stud 13 and a bail 22. Plunger pin 12 is inserted into bores 17 and 19 of main body 14 and bore 21 of hook 16 against spring 18, which is also inserted into main body 14. Plunger pin 12 is held captive in main body 14 by lock pin 20. Bail 22 is attached to main body 14 with threaded or welded stud 13 and is fixed to member 24 being connected by snap shackle 10. The hook 16 is attached to main body 14 by a pivot pin 11. Plunger pin 12, main body 14, and hook 16, are assembled in such a way that when plunger pin 12 is engaged in hook 16, hook 16 may not freely rotate about pivot pin 11 with respect to main body 14. When translated enough, plunger pin 12 disengages from hook 16 and allows rotation of hook 16 about pivot pin 11. In this configuration, member 36 being connected by snap shackle 10 is allowed to slip free from hook 16. At this point, members 24 and 36 are no longer physically connected together.

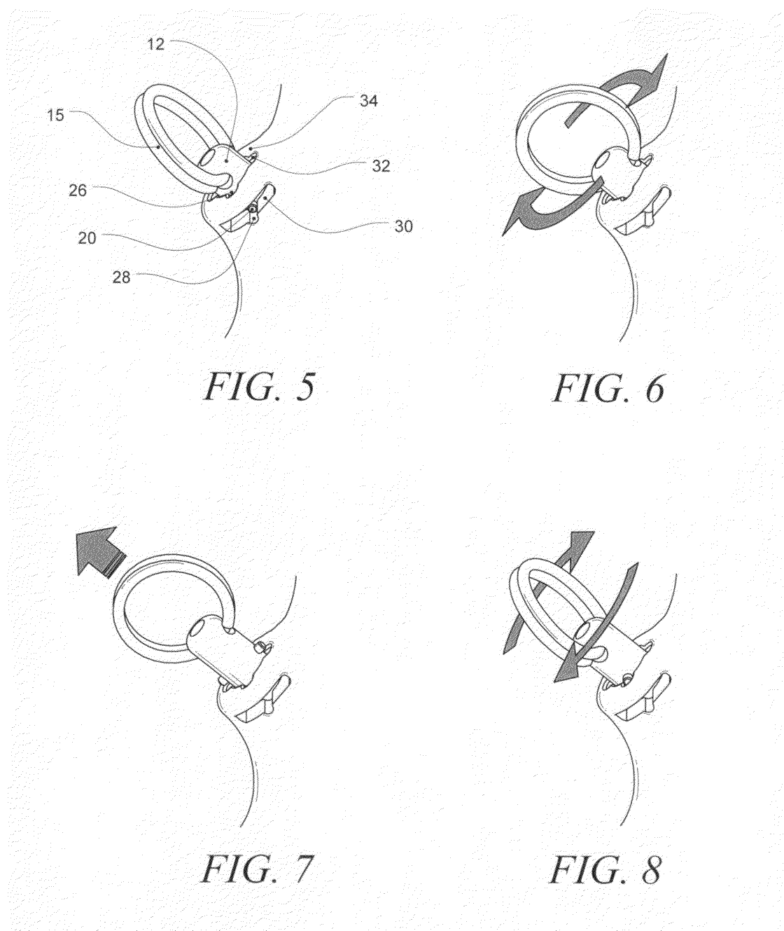

Plunger pin 12 may exist at two distinct “at rest” positions; the unlocked position illustrated in FIG. 8 and the locked position illustrated in FIG. 5.

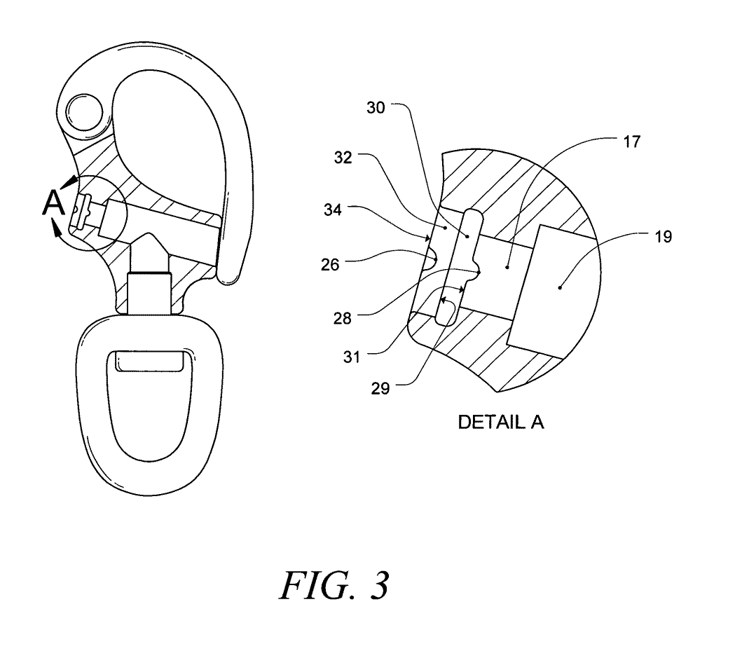

In the unlocked state of plunger pin snap shackle 10 illustrated in FIG. 8 with components further detailed in FIG. 3 and FIG. 5, plunger pin 12 may translate vertically over a range between the point at which spring 18 reaches its solid height and the point at which lock pin 20 comes in contact with main body 14. In this state, plunger pin 12 may be translated enough to disengage from hook 16. When “at rest” in the unlocked state, lock pin 20 rests in upper divots 26 in the main body 14.

The locked state of plunger pin snap shackle 10 is illustrated in FIG. 5 with the components further detailed in FIG. 3. Plunger pin 12 may translate vertically over a range between the point at which lock pin 20 comes in contact with top surface 29 of locking cavity 30 in main body 14 and the point at which lock pin 20 comes in contact with bottom surface 31 of locking cavity 30 in main body 14. In this state, plunger pin 12 may not translate enough to disengage from hook 16. When “at rest” in the locked state, lock pin 20 rests in lower divots 28 in main body 14.

In order to switch plunger pin snap shackle 10 from the locked state shown in FIG. 5 to the unlocked state shown in FIG. 8, plunger pin 12 is translated up slightly to clear lower divots 28 as further detailed in FIG. 3, then rotated ninety degrees about the vertical axis of plunger pin 12, then translated out through the open slot 32 until lock pin 20 clears the outside surface 34 of main body 14. Plunger pin 12 is again rotated ninety degrees and seated down into upper divots 26. The reverse procedure is performed to switch plunger pin snap shackle 10 from the unlocked state, shown in FIG. 8, to the locked state, shown in FIG. 5.

When lock pin 20 is “at rest” in either upper divots 26 or lower divots 28, plunger pin 12 resists rotation.

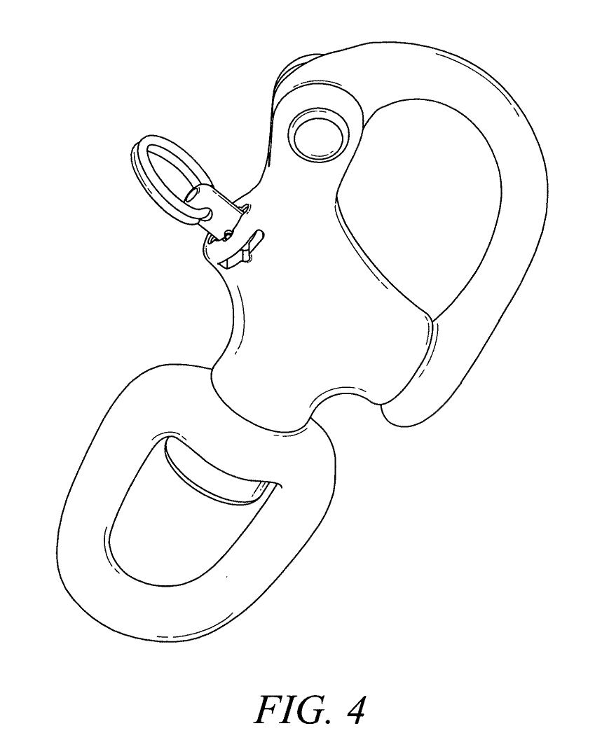

FIG. 4 provides an isometric view of the finished shackle.

Although the present invention has been described with reference to certain preferred embodiments thereof, other versions are readily apparent to those of ordinary skill in the preferred embodiments contained herein.

What is claimed is:

1. A plunger pin snap shackle having a main body with a plunger pin bore, a plunger pin, a plunger spring, a hook having a hook bore and a bail with said hook and said bail used to join two members together, with a first member attached to said hook and a second member attached to said bail, said shackle comprising:
a locking mechanism having two “at rest” positions, a first position for locking said plunger pin within the bore of said hook wherein said two members are joined together and a second position for releasing said plunger pin such that said hook is free to rotate to release said first member wherein said two members are no longer attached to one another.

2. The plunger pin snap shackle of claim 1 wherein said locking mechanism further comprises:
a snap ring affixed within one end of said plunger pin such that said plunger pin is rotatable and translatable by said snap ring within the plunger pin bore of said main body, wherein rotating said plunger pin one way results in said first position and rotating said plunger pin approximately 90 degrees from the radial position of said plunger pin that provides said first position then results in said second position.

3. The plunger pin snap shackle of claim 2 where said locking mechanism further comprises:
a lock pin transversely affixed there through said plunger pin;
an upper divot that supports said lock pin when said plunger pin is in said second position so that said hook is free to rotate;
a lower divot that supports said lock pin in said first position and wherein when said lock pin is within either the upper or lower divot, said plunger pin resists rotation due to said plunger spring urging said lock pin against said divot that is in use.

4. The plunger pin snap shackle of claim 3 further comprising a locking cavity in said main body such that said plunger pin and its said lock pin may be translated within said main body along a longitudinal axis of said plunger pin and rotated by said snap ring so that said shackle may be changed back and forth from said first position to said second position.
